(19) United States
(12) Patent Application Publication
(10) Pub. No.: US 2008/0072017 A1
(43) Pub. Date: Mar. 20, 2008

(54) Processing System having a Plurality of Processing Units with Program Counters and Related Method for Processing Instructions in the Processing System

(76) Inventor: Hsueh-Bing Yen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/532,918

(22) Filed: Sep. 19, 2006

(51) Int. Cl. G06F 9/30

(52) U.S. Cl. 712/214

(57) ABSTRACT

A method for processing predetermined instructions in a processing system having a plurality of processing units includes providing a global program counter and setting a counter value of the global program counter as an instruction of the predetermined instructions is executed; assigning each processing unit a local program counter and setting a counter value of the local program counter according to a current instruction being executed by the processing unit; and enabling at least one of the processing units to execute a specific instruction of the predetermined instructions according to counter values stored in local program counters of the processing units and the global program counter.

### BACKGROUND OF THE INVENTION

1. Field of the Invention

The present invention relates generally to a method for processing predetermined instructions in a processing system having a plurality of processing units, and more particularly, to a processing system having a plurality of processing units providing local program counters for each of the plurality of the processing units and related method for processing predetermined instructions in the processing system.

2. Description of the Prior Art

Traditional flow control in single instruction multiple data (SIMD) processing systems is difficult to control. The introduction of nested flow control exacerbates this problem. Conventional methods exist but those conventional methods achieve partial success with the waste of hardware resources to solve the problem of said nested flow control.

It is often desirable, especially in the field of graphics processing, to utilize SIMD parallel processing computer architecture. However, the nature of SIMD is too restrictive. A problem that quickly arises is that the plurality of SIMD processing units of the parallel processing system must all follow the program counter. Specifically, there is one program counter for all of the SIMD processing units.

Therefore, it is apparent that new and improved methods and devices are needed to solve the aforementioned problems.

### SUMMARY OF THE INVENTION

It is therefore one of the objectives of the claimed invention to provide a processing system having a plurality of processing units with local program counters and the related method for processing predetermined instructions in the processing system, to solve the aforementioned problems.

According to an embodiment of the claimed invention, a method for processing predetermined instructions in a processing system having a plurality of processing units is disclosed. The method includes providing a global program counter and setting a counter value of the global program counter as an instruction of the predetermined instructions is executed; assigning each processing unit a local program counter and setting a counter value of the local program counter according to a current instruction being executed by the processing unit; and enabling at least one of the processing units to execute a specific instruction of the predetermined instructions according to counter values stored in local program counters of the processing units and the global program counter.

According to an embodiment of the claimed invention, a processing system for processing predetermined instructions in a processing system having a plurality of processing units is disclosed. The processing system includes an instruction buffer, for receiving and buffering the predetermined instructions; a global program counter, coupled to the instruction buffer, for storing a counter value as an instruction of the predetermined instructions is executed; a plurality of processing units each having: an execution unit for instruction execution; and a local program counter for setting a counter value according to a current instruction being executed by the execution unit; and a flow control unit, coupled to the global program counter and each processing unit, for enabling at least one of the processing units to execute a specific instruction of the predetermined instructions according to counter values stored in local program counters of the processing units and the global program counter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of processing system for processing predetermined instructions according to an embodiment of the present invention.

FIG. 2 is a flow chart showing a method for processing predetermined instructions according to an embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

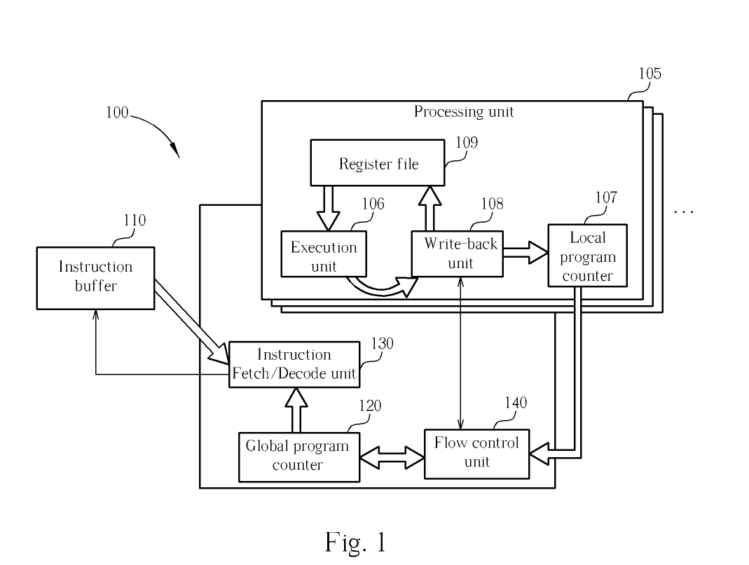

Please refer to FIG. 1. FIG. 1 is a simplified block diagram of a processing system 100 for processing predetermined instructions according to an embodiment of the present invention. In FIG. 1, the small arrow symbol represents a control path, which controls which operation to be executed and the execution result to be written into a specific register, while the large arrow symbol represents a data path, which contains instructions and data. The processing system 100 includes an instruction buffer 110. The instruction buffer 110 is utilized for receiving and buffering the predetermined instructions to be processed. A global program counter 120 is coupled to the instruction buffer 110. The global program counter 120 is utilized for storing a counter value as an instruction of the predetermined instructions is executed. A plurality of processing units 105 is included. Each of the processing units 105 includes an execution unit 106 and a local program counter 107. The execution unit 106 is utilized for instruction execution of the predetermined instructions stored in the instruction buffer 110. The local program counter 107 is utilized for setting a counter value according to a current instruction being executed by the execution unit 106.

Additionally, the processing system 100 includes a flow control unit 140. The flow control unit 140 is coupled to the global program counter 120 and each of the plurality of processing units 105. The flow control unit 140 is utilized for enabling at least one of the processing units 105 to execute a specific instruction of the predetermined instructions according to counter values stored in local program counters 107 of the processing units 105 and the global program counter 120.

Additionally, the flow control unit 140 of the processing system 100 can enable a specific processing unit 105 to execute a specific instruction currently pointed to by the global program counter 120 when the specific counter value stored in the specific local program counter 107 of the specific processing unit 105 is equal to the counter value of the global program counter 120.

Additionally, the specific local program counter 107 of the processing system 100 of a specific processing unit 105 can maintain a specific counter value stored in the specific local program counter 107 when the specific processing unit 105 of the processing units 105 is not enabled by the flow control unit 140 to execute the specific instruction.

Additionally, the flow control unit 140 of the processing system 100 controls the specific local program counter 107 to increment the specific counter value stored in the specific local program counter 107 when the specific instruction is not a flow control instruction.

Additionally, the execution unit 106 of the specific processing unit 105 of the processing system 100 evaluates the flow control instruction when the specific instruction is a flow control instruction, and the flow control unit 140 updates the specific counter value stored in the specific local program counter 107 according to an evaluation result produced by the execution unit 106.

Additionally, the flow control unit 106 increments the specific counter value stored in the specific local program counter 107 when the flow control instruction (or the branch instruction) is not taken, and the flow control unit 140 assigns a predetermined target address corresponding to another instruction to the specific counter value stored in the specific local program counter 107 when the flow control instruction (or the branch instruction) is taken.

In another embodiment of the present invention, the processing units 105 each further include a call status bit (not shown), for indicating when the processing unit 105 is executing instructions within a call block or a nested call block. This is important because the local program counter 107 having the smallest local program counter value will also result in the corresponding processing unit 105 to execute the instruction. But, each processing unit 105 can have the call status bit, and the call status bit is set when the processing unit 105 executes a first instruction that enters a call block or a nested call block, and the call status bit is cleared when the processing unit 105 executes a second instruction that exists the call block or the top level nested call block. In this case, the processing units 105 having their call status bits set are considered first as a group and of said group the processing units 105 with the smallest local program counter value will also result in the corresponding processing unit 105 to execute the instruction. When no call status bits are set, then the rule simply returns to the aforementioned scheme whereby the processing unit 105 will execute the instruction if it has the smallest corresponding local program counter value and since none of the call status bits are set, the call status bits have no effect here.

In other words, in this embodiment the processing unit 105 with a call status bit set is assigned with a higher priority to fetch and execute an instruction. In this way, the processing units 105 with respective call status bits set are enabled prior to those without respective call status bits set. For example, assume that a first processing unit with a local program counter value set by M has a call status bit set; and a second processing unit with a local program counter value set by M-1 has a call status bit cleared. In this embodiment, an instruction pointed to by the greater local program count value M is fetched and executed because the call status bit of the first processing unit is set.

Finally, the processing unit 105 of the processing system 100 for processing predetermined instructions further includes a write-back unit 108 and a register file 109. In this embodiment of the present invention, the flow control unit 140 is utilized for controlling the execution unit 106 to execute the instructions that follow the flow control instruction according to the local program counter 107 and to control the write-back unit 108 to write the execution result into the register file 109.

It is by way of example and not limitation to the present invention, that the provided examples and embodiments are presented within the context of the processing system 100 being a parallel processing system, and the processing units 105 being parallel processing units. However, it is easily understood by one having average skill in this art, that this is not a requirement of the present invention and other related processing system, especially those related to the parallel processing systems of the conventional art, can be utilized with the present invention and that the present invention can be easily integrated with said convention methods and devices, therefore, said parallel systems, processes, methods, and devices, are all within the scope of the present invention.

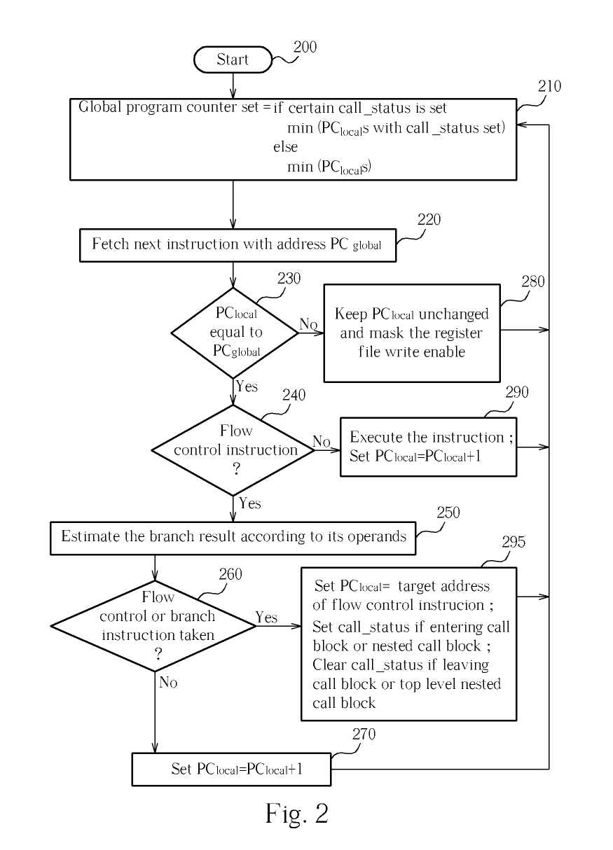

Please refer to FIG. 2. FIG. 2 is a flow chart showing a method for processing predetermined instructions according to an embodiment of the present invention. The method for processing predetermined instructions is performed by the processing system 100 shown in FIG. 1. The flow of the present invention as illustrated in FIG. 2 includes:

Step 200: Start.

Step 210: Set the global program counter 120 to be equal to the minimum of the local program counter of each of the processing unit(s) 105 with respective call status bit(s) set; otherwise, set the global program counter 120 to be equal to the minimum of the local program counter of each of the processing units 105 if there is no call status bit set.

Step 220: Fetch the next instruction pointed to by the global program counter 105.

Step 230: For each processing unit, is the global program counter 120 equal to the local program counter 107? If yes, go to step 280. If no, then go to step 240.

Step 240: Is the current instruction a flow control instruction? If yes, then go to step 250. If no, then go to step 290.

Step 250: Evaluate the operands of the current instruction to determine the flow control result. Go to step 260.

Step 260: Does certain processing unit 105 evaluate to true for taking the flow control result, that is, is the branch instruction taken? If yes, then go to step 295. If no, then go to step 270.

Step 270: Set the local program counter 107 equal to the local program counter 107 plus one. Go to step 210.

Step 280: Keep the local program counter 107 unchanged. Mask the register file 109 to prevent write enable. Go to step 210.

Step 290: Execute the current instruction, and set the local program counter 107 equal to the local program counter 107 plus one. Go to step 210.

Step 295: Set the local program counter 107 equal to the target address associated with the currently executing flow control instruction. Set the call status bit if execution of the current flow instruction enters a call block. Clear the call status bit if execution of the current flow instruction leaves a call block. Go to step 210.

The flow of the present invention begins with step 200. In step 210, the global program counter 120 is set to be equal to the minimum of the local program counter 107 of each of the processing units 105 if there is no call status bit set. However, as mentioned above, the processing unit 105 with a call status bit set is assigned with a higher priority to fetch and execute an instruction. Therefore, if at least a call status bit is set, the flow will enabled the corresponding processing unit 105 with a call status bit set prior to enabling those having call status bits cleared. As shown in FIG. 2, the global program counter 120 is set by the minimum of the local program counter value(s) of the processing unit(s) 105 with respective call status bit(s) set.

Next, in step 220 the next instruction is fetched according to the global program counter 120. In step 230, for each processing unit 105, the present invention checks to see if the global program counter (PC_{global}) 120 is equal to the local program counter (PC_{local}) 107. If the global program counter 120 is equal to a specific local program counter 107 then the flow goes to step 240 otherwise the flow goes to step 280. Continuing with step 240, we know at this point that the said two program counters, the global program counter 120 and the local program counter 107, are equal so now the present invention must determine if the current instruction is a flow control instruction. If the current instruction is a flow control instruction then the flow goes to step 250, otherwise the flow goes to step 290. Continuing with step 250, we know at this point that the current instruction is a flow control instruction, and therefore in step 250 the operands of the current flow control instruction are evaluated to determine the flow control result. Next, the flow continues to step 260. In step 260, if certain processing unit 105 evaluates to the branch taken result, in other words, the processing unit 105 evaluates the flow control instruction and it will take flow control, then the present invention goes to step 295. If the processing unit 105 evaluates the current flow control instruction to be the branch not taken result, then the flow of the present invention goes to step 270. Continuing with step 270, the local program counter 107 is set to be equal to the local program counter 107 plus one (i.e., PC_{local}=PC_{local+1}) and the flow continues to step 210.

Returning to step 230, if the global program counter 120 is not equal to a specific local program counter 107 then the flow proceeds to step 280, wherein the present invention keeps (i.e., maintains) the local program counter 107 to be unchanged for it current value. Additionally, the register file 109 is masked to prevent write enable. Next, the flow returns to step 210.

Returning to step 240, in step 240 we know at this point that the said two program counters are equal so now the present invention must determine if the current instruction is a flow control instruction. If the current instruction is not a flow control instruction then the flow goes to step 290. In step 290, the execution unit 106 executes the current instruction. Additionally, the local program counter 107 is set to be equal to the local program counter 107 plus one (i.e., PC_{local}=PC_{local}+1) and the flow returns to step 210.

Returning to step 260, if the processing unit 105 evaluates the current flow control instruction to be the branch taken result, that is, the branch is taken, then the flow of the present invention goes to step 295. In step 295, the local program counter 107 is set to be equal to the target address associated with the currently executing flow control instruction being executed by the execution unit 106 and the flow then returns to step 210. Additionally, if execution of the current flow control instruction enters a call block, a currently cleared call status bit is set accordingly; however, if the currently executing flow control instruction leaves a call block, a currently set call status bit is cleared (reset) accordingly.

Please note, by way of example and not limitation of the present invention, the flow control instruction as utilized in the provided examples and embodiment can be an IF flow control instruction. Also, it is within the scope of the present invention that using the disclosed flow control architecture with local program counters allows the predetermined instructions to include an IF flow control instruction with no corresponding termination flow control instruction, EndIF flow control instruction.

It should be noted that the operation of comparing the counter value stored in the global program counter 120 with the counter values stored in the local program counters 107 in respective processing units 105 is to identify processing unit(s) having the smallest local program counter value as indicated by the counter value stored in the global program counter 120. However, other implementations are possible. For example, the flow control unit 140 compares the counter values stored in the local program counters 107 of respective processing units 105 to identifying processing unit(s) having the smallest local program counter value. Next, the instruction buffer 110 provides the instruction to be executed according to a comparing result generated by the flow control unit 140, and execution units 106 in the identified processing units 105 are enabled by the flow control unit 140 to execute the instruction according to the comparing result. In short, the operation of the flow control unit 140 is equivalent to comparing a reference value with a counter value of one local program counter 107 to generate a comparing result, where the reference value could be a counter value stored in the global program counter, or a counter value of another local program counter 107, or a value given by other circuit components according to desired design requirements. Therefore, the instruction buffer 110 is operative to provide the instruction according to the comparing result, and an execution unit 106 is enabled by the flow control unit 140 to execute the instruction according to the comparing result.

In summary, the present invention provides many processing units each with its own local program counter. The execution units having the smallest local program counters execute the current instruction while the other processing units do not. In a nested flow control situation, those processing units that are executing nested instructions are classified together and their local program counters are checked first with respect to the smallest local program counter regarding which processing units will execute the current instruction. Processing units are easily classified as being in or not in a nested flow control situation via, for example, a status bit. Using target addresses associated with the flow control instructions it is possible for the present invention to achieve greater efficiency by offering an early-out (i.e., exiting a nested flow control situation earlier than would normally be the case) when it is obvious that all processing units will evaluate the flow control instruction such that the flow is not taken but rather exited.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing predetermined instructions in a processing system having a plurality of processing units, the method comprising:
(a) providing a global program counter and setting a counter value of the global program counter as an instruction of the predetermined instructions is executed;
(b) assigning each processing unit a local program counter and setting a counter value of the local program counter according to a current instruction being executed by the processing unit; and
(c) enabling at least one of the processing units to execute a specific instruction of the predetermined instructions according to counter values stored in local program counters of the processing units and the global program counter.

2. The method of claim 1, wherein step (c) comprises:
enabling a specific processing unit having a specific local program counter storing a specific counter value that is equal to the counter value of the global program counter to execute the specific instruction currently pointed to by the global program counter.

3. The method of claim 1, wherein step (b) comprises:
if a specific processing unit of the processing units is not enabled to execute the specific instruction, maintaining a specific counter value stored in a specific local program counter of the specific processing unit.

4. The method of claim 2, wherein the specific instruction is not a flow control instruction, and step (b) comprises incrementing the specific counter value stored in the specific local program counter.

5. The method of claim 2, wherein the specific instruction is a flow control instruction, and step (b) comprises:
evaluating the flow control instruction; and
updating the specific counter value stored in the specific local program counter according to an evaluation result.

6. The method of claim 5, wherein the step of updating the specific counter value comprises:
if the evaluation result makes the flow control or branch instruction not taken, incrementing the specific counter value stored in the specific local program counter; and
if the evaluation result makes the flow control or branch instruction
taken, assigning a predetermined target address corresponding to another instruction to the specific counter value stored in the specific local program counter.

7. The method of claim 1, wherein the processing system is a parallel processing system, and the processing units are parallel processing units.

8. The method of claim 1, wherein each processing unit has a call status bit, the call status bit is set when the processing unit executes a first instruction that enters a call block or a nested call block, and the call status bit is cleared when the processing unit executes a second instruction that exists the call block or the top level nested call block.

9. The method of claim 1, wherein the predetermined instructions include a flow control instruction with no corresponding termination flow control instruction.

10. The method of claim 9, wherein the flow control instruction is an IF flow control instruction.

11. A processing system for processing predetermined instructions, the processing system comprising:
an instruction buffer, for receiving and buffering the predetermined instructions;
a global program counter, coupled to the instruction buffer, for storing a counter value as an instruction of the predetermined instructions is executed;
a plurality of processing units each having:
an execution unit for instruction execution; and
a local program counter for setting a counter value according to a current instruction being executed by the execution unit; and
a flow control unit, coupled to the global program counter and each processing unit, for enabling at least one of the processing units to execute a specific instruction of the predetermined instructions according to counter values stored in local program counters of the processing units and the global program counter.

12. The processing system of claim 11, wherein the flow control unit enables a specific processing unit to execute the specific instruction currently pointed to by the global program counter when the specific counter value stores in the specific local program counter of the specific processing unit is equal to the counter value of the global program counter.

13. The processing system of claim 11, wherein a specific local program counter of a specific processing unit maintains a specific counter value stores in the specific local program counter when the specific processing unit of the processing units is not enabled to execute the specific instruction.

14. The processing system of claim 12, wherein the specific instruction is not a flow control instruction, and the flow control unit controls the specific local program counter to increment the specific counter value stored in the specific local program counter.

15. The processing system of claim 12, wherein the specific instruction is a flow control instruction, the execution unit of the specific processing unit evaluates the flow control instruction, and the flow control unit updates the specific counter value stored in the specific local program counter according to an evaluation result.

16. The processing system of claim 15, wherein the flow control unit increments the specific counter value stored in the specific local program counter when the evaluation result makes the flow control or branch instruction not taken, and the flow control unit assigns a predetermined target address corresponding to another instruction to the specific counter value stored in the specific local program counter when the evaluation result makes the flow control or branch instruction taken.

17. The processing system of claim 11, wherein the processing system is a parallel processing system, and the processing units are parallel processing units.

18. The processing system of claim 11, wherein the processing units each further comprise:
a call status bit, for indicating when the processing unit is executing instructions within a call block or a nested call block.

19. The processing system of claim 11, wherein the predetermined instructions include a flow control instruction with no corresponding termination flow control instruction.

20. The processing system of claim 19, wherein the flow control instruction is an IF flow control instruction.

21. A method for processing predetermined instructions in a processing system having a plurality of processing units, the method comprising:
(a) comparing a plurality of counter values stored in a plurality of local program counters to generate a comparing result, wherein the counter values are assigned to the processing units, respectively;
(b) providing an instruction of the predetermined instructions according to the comparing result; and
(c) enabling a specific processing unit of the processing units to execute the instruction according to the comparing result.

22. The method of claim 21, further comprising:
(d) if a processing unit of the processing units is not enabled to execute the instruction, maintaining a counter value stored in a local program counter assigned to the processing unit.

23. The method of claim 21, wherein if the instruction is not a flow control instruction, step (c) further comprises: incrementing a specific counter value stored in a specific local program counter assigned to the specific processing unit.

24. The method of claim 21, wherein if the instruction is a flow control instruction, step (c) further comprises:
evaluating the flow control instruction; and
updating a specific counter value stored in a specific local program counter assigned to the specific processing unit according to an evaluation result.

25. The method of claim 24, wherein the step of updating the specific counter value comprises:
if the evaluation result makes the flow control or branch instruction not taken, incrementing the specific counter value stored in the specific local program counter; and
if the evaluation result makes the flow control or branch instruction taken, assigning a predetermined target address corresponding to another instruction to the specific counter value stored in the specific local program counter.

26. A processing system for processing predetermined instructions, the processing system comprising:
a plurality of local program counters coupled to a plurality of processing units, wherein the local program counters store a plurality of counter values, respectively;
a flow control unit coupled to the local program counters and comparing the counter values;
an instruction buffer, receiving and buffering an instruction of the predetermined instructions, and providing the instruction according to a comparing result generated by the flow control unit; and
an execution unit coupled to the instruction buffer and enabled by the flow control unit to execute the instruction according to the comparing result.

27. The processing system of claim 26, wherein if the execution unit is not enabled to execute the instruction, a specific counter value stored in a specific local program counter corresponding to the execution unit is maintained.

28. The processing system of claim 26, wherein if the instruction is not a flow control instruction, the flow control unit further increments a specific counter value stored in a specific local program counter corresponding to the execution unit.

29. The processing system of claim 26, wherein if the instruction is a flow control instruction, the execution unit evaluates the flow control instruction, and the flow control unit updates a specific counter value stored in a specific local program counter corresponding to the execution unit according to an evaluation result.

30. The processing system of claim 29, wherein the flow control unit increments the specific counter value stored in the specific local program counter if the evaluation result makes the flow control or branch instruction not taken, and assigns a predetermined target address corresponding to another instruction to the specific counter value stored in the specific local program counter if the evaluation result makes the flow control or branch instruction taken.

31. A processing system for processing predetermined instructions, the processing system comprising:
a local program counter coupled to a processing unit, wherein the local program counter stores a counter value;
a flow control unit coupled to the local program counter and comparing a reference value with the counter value;
an instruction buffer, receiving and buffering an instruction of the predetermined instructions, and providing the instruction according to a comparing result generated by the comparing unit; and
an execution unit coupled to the instruction buffer and enabled by the flow control unit to execute the instruction according to the comparing result.

32. The processing system of claim 31, wherein the flow control unit enables the execution unit to execute the instruction when the counter value is equal to the reference value.

33. The processing system of claim 31, wherein if the instruction is not a flow control instruction, the flow control unit further increments the counter value stored in the local program counter corresponding to the execution unit.

34. The processing system of claim 31, wherein if the instruction is a flow control instruction, the execution unit evaluates the flow control instruction, and the flow control unit updates the counter value stored in the local program counter corresponding to the execution unit according to an evaluation result.

35. The processing system of claim 34, wherein the flow control unit increments the counter value stored in the local program counter if the evaluation result makes the flow control or branch instruction not taken, and assigns a predetermined target address corresponding to another instruction to the counter value stored in the local program counter if the evaluation result makes the flow control or branch instruction taken.

36. A method for processing predetermined instructions in a processing system, the method comprising:
(a) comparing a reference value and a counter value stored in a local program counter assigned to a processing unit to generate a comparing result;
(b) providing an instruction of the predetermined instructions according to the comparing result; and
(c) enabling the processing unit to execute the instruction according to the comparing result.

37. The method of claim 36, wherein step (c) is performed when the counter value is equal to the reference value.

38. The method of claim 36, wherein if the instruction is not a flow control instruction, step (c) further comprises: incrementing the counter value stored in the local program counter.

39. The method of claim 36, wherein if the instruction is a flow control instruction, step (c) further comprises:
evaluating the flow control instruction; and
updating the counter value stored in the local program counter according to an evaluation result.

40. The method of claim 39, wherein the step of updating the counter value comprises:
if the evaluation result makes the flow control or branch instruction not taken, incrementing the counter value stored in the local program counter; and
if the evaluation result makes the flow control or branch instruction taken, assigning a predetermined target address corresponding to another instruction to the counter value stored in the local program counter.
